(19) United States
(12) Patent Application Publication
(10) Pub. No.: US 2015/0092407 A1
(43) Pub. Date: Apr. 2, 2015

(54) HIGH COLOR RENDERING LAMP

(71) Applicant: Genius Electronic Optical Co., Ltd., Taichung City (TW)

(72) Inventors: Shih-Jung WEN, Hsinchu County (TW); Xing-Ping CAI, Fujian Province (CN)

(73) Assignee: Genius Electronic Optical Co., Ltd., Taichung City (TW)

(21) Appl. No.: 14/106,717

(22) Filed: Dec. 14, 2013

(30) Foreign Application Priority Data
Sep. 27, 2013 (CN) 201310451984.0

(51) Int. Cl. F21K 99/00; F21V 23/02

(52) U.S. Cl. CPC F21K 9/00; F21V 23/02
USPC 362/231

(57) ABSTRACT

A high color rendering lamp includes: a light source with a substrate, a base light emitting unit and a compensation light unit, and a power source. The base light emitting unit includes a plurality of white LEDs disposed in a spaced manner on the substrate. The fill light unit includes a plurality of red LEDs disposed in a spaced manner on the substrate, and the red LEDs include short and long wavelength red LEDs, a wavelength of a light of the short wavelength red LEDs is shorter than that of the long wavelength red LEDs. The power source is electrically connected to the substrate and supplies power to the substrate. The red and white lights within two specific wavelength ranges are mixed together in a specific proportion, so that the CRI can be increased to more than 90, and the practicability is also considerably increased.

### BACKGROUND OF THE INVENTION

1. Field of the Invention

The present invention relates to a lamp, and more particularly to a high color rendering (CRI) lamp.

2. Description of the Prior Art

A conventional LED lamp essentially comprises blue light emitting diodes with yellow phosphor, the blue light is used to stimulate the phosphor to emit yellow light. Finally, the blue light and yellow light are mixed to produce white light. However, the white light lacks red light wavelength, hence, the light of the conventional LED lamp is too cold, which can't satisfy with the high color rendering requirement.

A conventional technique was proposed to improve the color rendering performance by mixing white light, red light and green light LEDs together. However, the improvement of color rendering performance is still a question.

Furthermore, the wavelength ranges of the different color LEDs are also different, when three different color light LEDs of different wavelengths are mixed together, the resultant color rendering performance will be different and undecided due to the undecided wavelength. Therefore, mixing different color light LEDs can surely and precisely improve and control the color rendering performance.

The present invention has arisen to mitigate and/or obviate the afore-described disadvantages.

### SUMMARY OF THE INVENTION

The primary objective of the present invention is to provide a high color rendering lamp which is capable of precisely providing high color rendering light.

To achieve the above objective, a high color rendering lamp in accordance with the present invention comprises: a light source with a substrate, a base light emitting unit and a compensation light unit, the base light emitting unit includes a plurality of white LEDs disposed in a spaced manner on the substrate. The compensation light unit includes a plurality of red LEDs disposed in a spaced manner on the substrate, and the red LEDs include short wavelength red LEDs and long wavelength red LEDs, a wavelength of a light of the short wavelength red LEDs is shorter than that of the long wavelength red LEDs.

A power source is electrically connected to the substrate and supplies power to the substrate to enable the base light emitting unit and the compensation light unit to generate light.

According to the present invention, the white lights and two specific wavelength red lights are mixed together in a specific proportion, so that the color rendering index Ra of the present invention has been increased to more than 90, and the practibility of the present invention is also considerably increased.

### BRIEF DESCRIPTION OF THE DRAWINGS

FIG. 1 is an illustrative view showing a light source of a high color rendering lamp in accordance with an embodiment of the present invention;

FIG. 2 is an illustrative view showing a light source of a high color rendering lamp in accordance with another embodiment of the present invention;

FIG. 3 is an illustrative view showing a substrate of a high color rendering lamp in accordance with another embodiment of the present invention;

FIG. 4 is an illustrative view showing the high color rendering lamp in accordance with the present invention;

FIG. 5A is a spectrum distribution graph of a high color rendering lamp in accordance with the present invention, wherein the white light LEDs are cold white light LEDs;

FIG. 5B is CIE color parameter and CRI (color rendering index) of FIG. 5A;

FIG. 6A is a spectrum distribution graph of a high color rendering lamp in accordance with the present invention, wherein the white light LEDs are warm white light LEDs;

FIG. 6B is CIE color parameter and CRI (color rendering index) of FIG. 6A; and

FIG. 7 is a diagram showing the corresponding application fields to different color rendering indexes.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

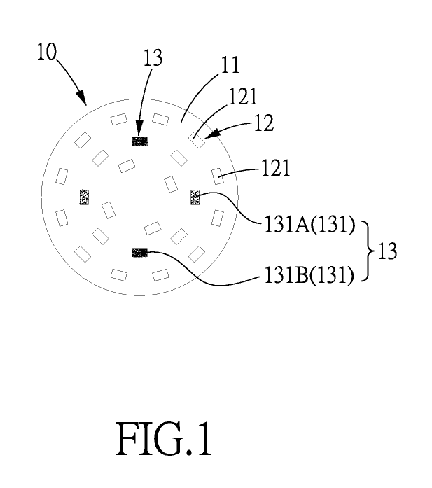

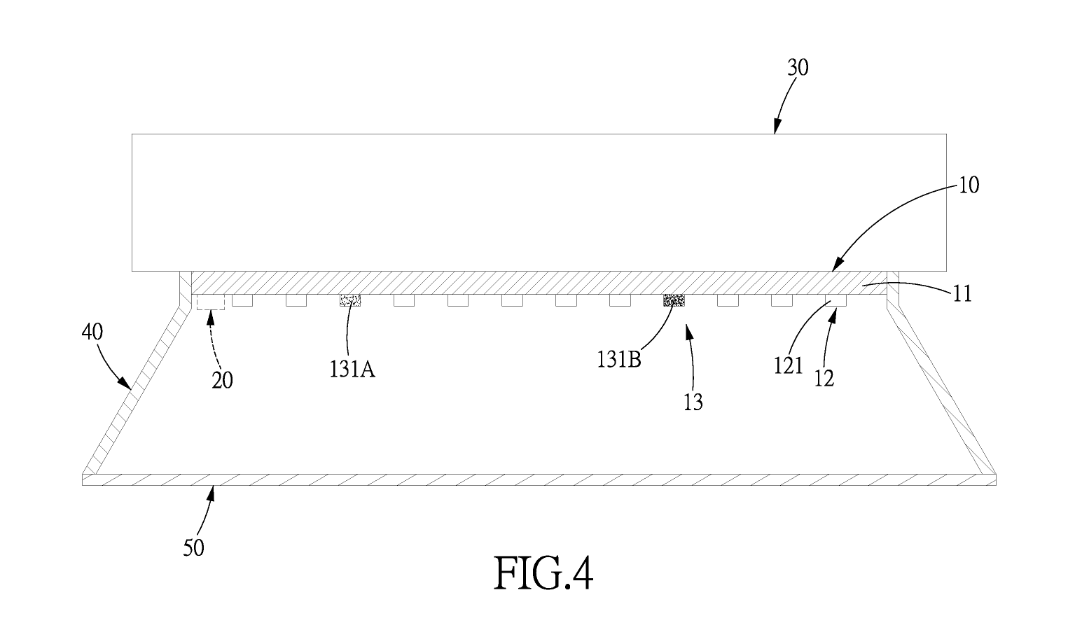

Referring to FIGS. 1-7, a high color rendering lamp in accordance with a preferred embodiment of the present invention comprises: a light source 10, a power source 20, a radiating member 30, a light reflection member 40, and a light diffuser shade 50.

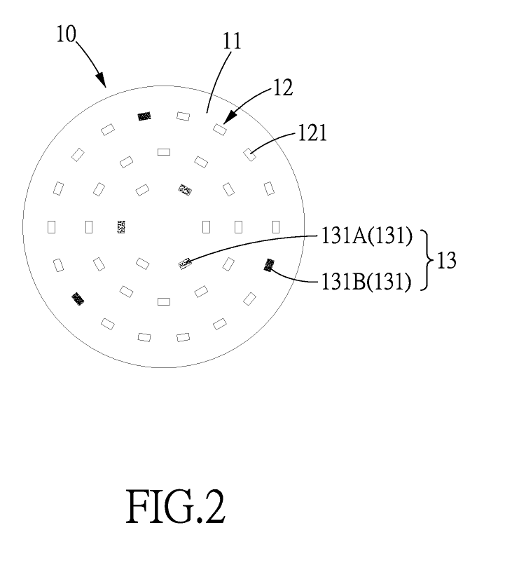

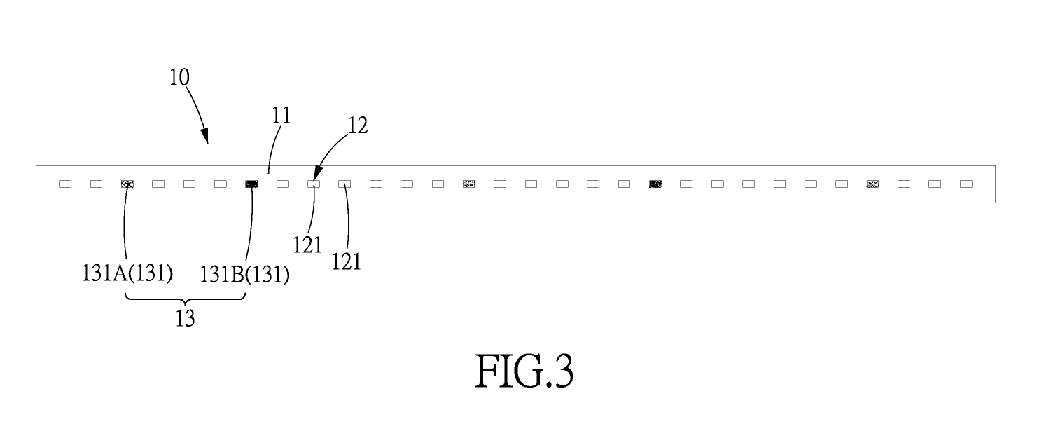

The light source 10 comprises a substrate 11, a base light emitting unit 12 and a compensation light unit 13. The base light emitting unit 12 includes a plurality of white LEDs (light emitting diodes) 121 disposed on the substrate 11, and the white LEDs 121 are spaced from one another. The compensation light unit 13 includes a plurality of red LEDs 131 disposed in a spaced manner on the substrate 11, and the red LEDs 131 are spaced from the white LEDs 121, and the red LEDs 131 include short wavelength red LEDs 131A and long wavelength red LEDs 131B. The wavelength of the light of the short wavelength red LEDs 131A is shorter than that of the long wavelength red LEDs 131B. The substrate 11 can be varied in shape, for example, it can be circular-shaped as shown in FIGS. 1 and 2, or rectangular-shaped, as shown in FIG. 3.

The proportion of the white LEDs 121 to the red LEDs 131 ranges from 3:1 to 6:1, in this range, the resultant mixed light has a better color rendering and brightness. In this embodiment, the proportion of the white LEDs 121 to the red LEDs 131 is 5:1, which better enhances the color rendering performance. As shown in FIG. 1, there are 20 white LEDs 121 and 4 red LEDs 131, and as shown in FIG. 2, there are 30 white LEDs 121 and 6 red LEDs 131. The proportion of the short wavelength red LEDs 131A to the long wavelength red LEDs 131B ranges from 1:2 to 2:1, and within this range, the two types of red light and the white light can be mixed to obtain a better color rendering light source. In this embodiment, the proportion of the short wavelength red LEDs 131A to the long wavelength red LEDs 131B is 1:1, which further improves the color rendering performance. As shown in FIGS. 1 and 2, the short wavelength red LEDs 131A and the long wavelength red LEDs 131B have two different and non-overlapped wavelength ranges selected from the range 620-750 nm. In this embodiment, the wavelengths of the short wavelength red LEDs 131A and the long wavelength red LEDs 131B are 620-670 nm and 670-750nm, respectively, or 620-640 nm and 650-670 nm. The difference between the red lights of the two different wavelength ranges is that the red light with wavelength of 620-640 nm and 650-670 nm has a better color rendering performance, while the red light with wavelength of 620-670 nm and 670-750 nm would contribute to cost reduction since the wavelength range is wide.

The power source 20 is electrically connected to the substrate 11 and supplies power to the substrate 11, so that the base light emitting unit 12 and the compensation light unit 13 can generate light.

The radiating member 30 is disposed at one side of the light source 10.

The light reflection member 40 surrounds the light source 10 and is located toward the base light emitting unit 12 and the compensation light unit 13.

The light diffuser shade 50 is fixed on the light reflection member 40 and located toward the base light emitting unit 12 and the compensation light unit 13. The light diffuser shade 50 can also be transparent.

With the white LEDs 121 used in combination with the red LEDs 131 of two different wavelengths, the present invention is able to provide high color rendering performance. With the restriction in the range of wavelength, the present invention is capable of precisely controlling the color rendering accuracy while ensuring the high color rendering illumination.

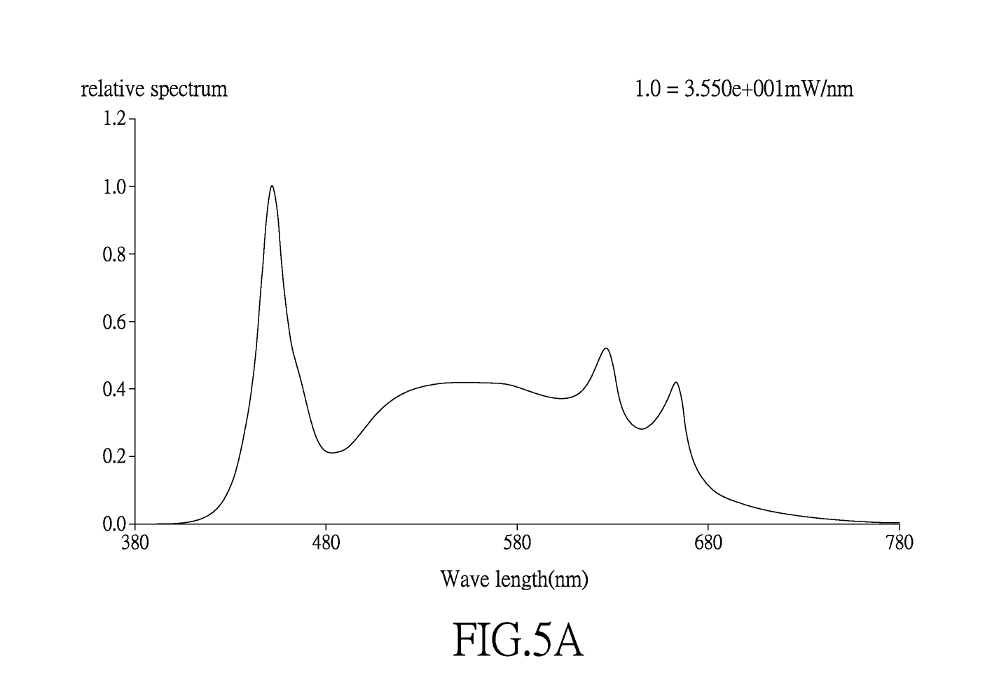

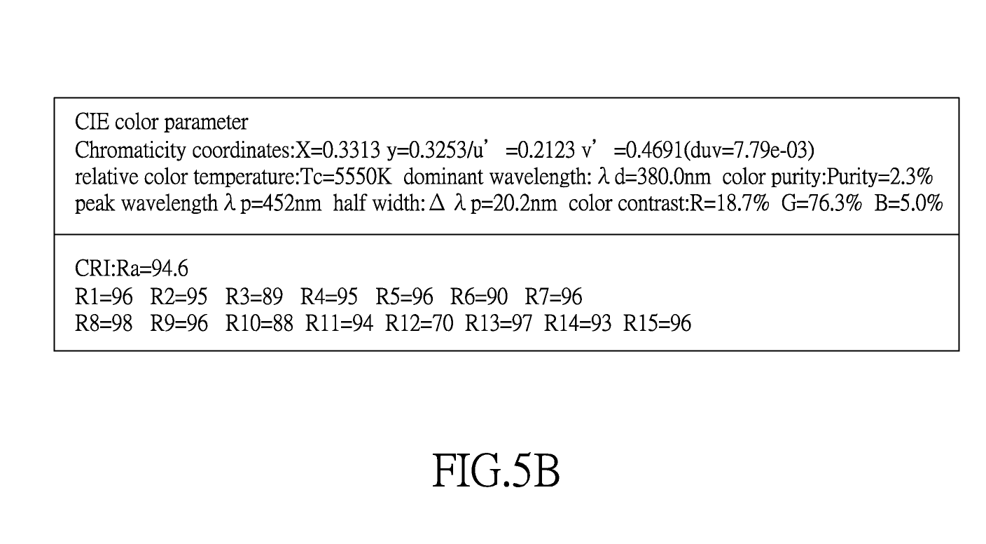

FIGS. 5A and 5B show the spectrum distribution, CIE color parameter and CRI (color rendering index) of an embodiment, measured according to the standard of CIE 1931, wherein the proportion of the white LEDs 121 to the red LEDs 131 is 5:1, the proportion of the short wavelength red LEDs 131A to the long wavelength red LEDs 131b is 1:1, the wavelength of the short wavelength red LEDs 131A is 620-640 nm, the wavelength of the long wavelength red LEDs 131B is 650-670 nm, the white LEDs 121 are cold white light LEDs, and the CRI average value is as high as 94.6.

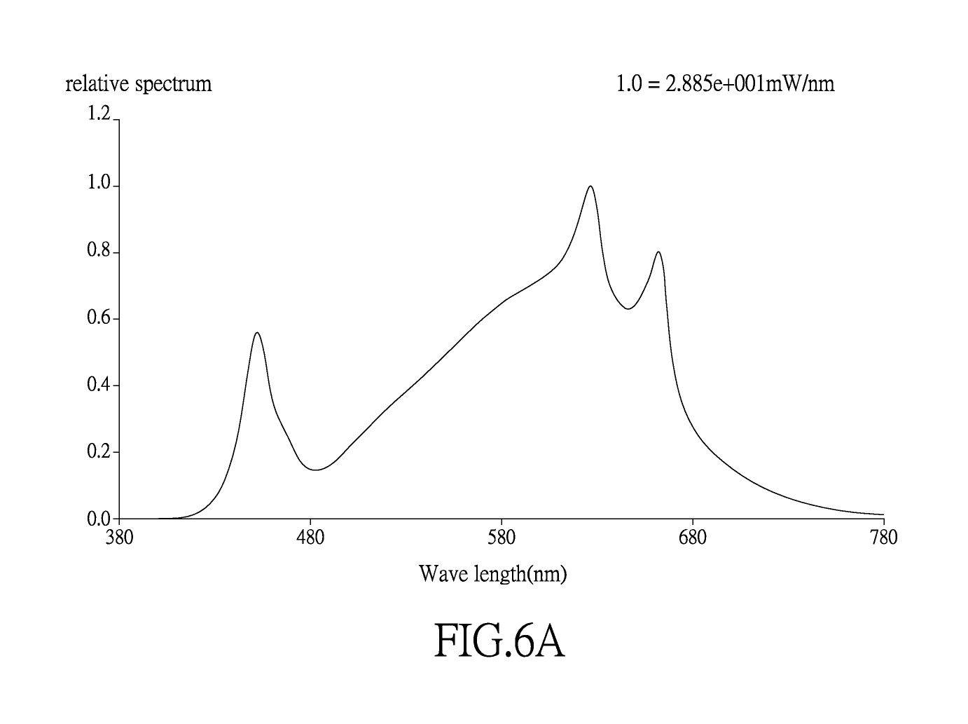

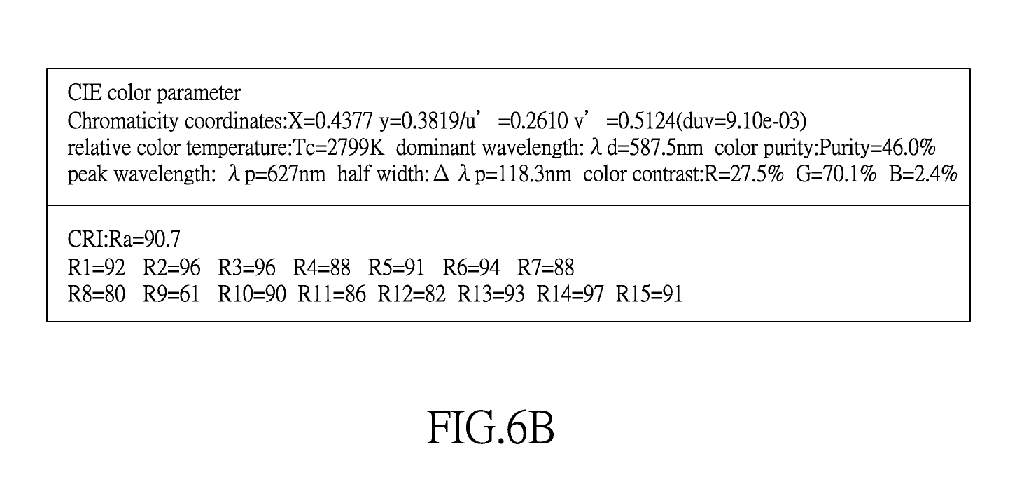

The lamp of another embodiment whose spectrum distribution, CIE color parameter and CRI (color rendering index) are shown in FIGS. 6A and 6B is similar to the previous embodiment, except that: the white light LEDs are warm white light LEDs instead of cold white light, and the CRI average value is 90.7.

It is learned from the above description that the white LEDs 121 are used in combination with the red LEDs 131 of two different wavelengths, and the proportion of the white LEDs 121 to the red LEDs 131, the proportion of the short wavelength red LEDs 131A to the long wavelength red LEDs 131b, and the wavelengths of all the LEDs have been specifically defined, so that the lamp of the present invention would surely be capable of providing a high color rendering performance. Furthermore, to further improve the stability of the lamp, the red LEDs 131 can be made of 40×40 mil large chips, so that the red LEDs 131 still can operate even if the current is lower than half of the rated current value, prevent color temperature drift and luminous decay caused by long time high-load operation.

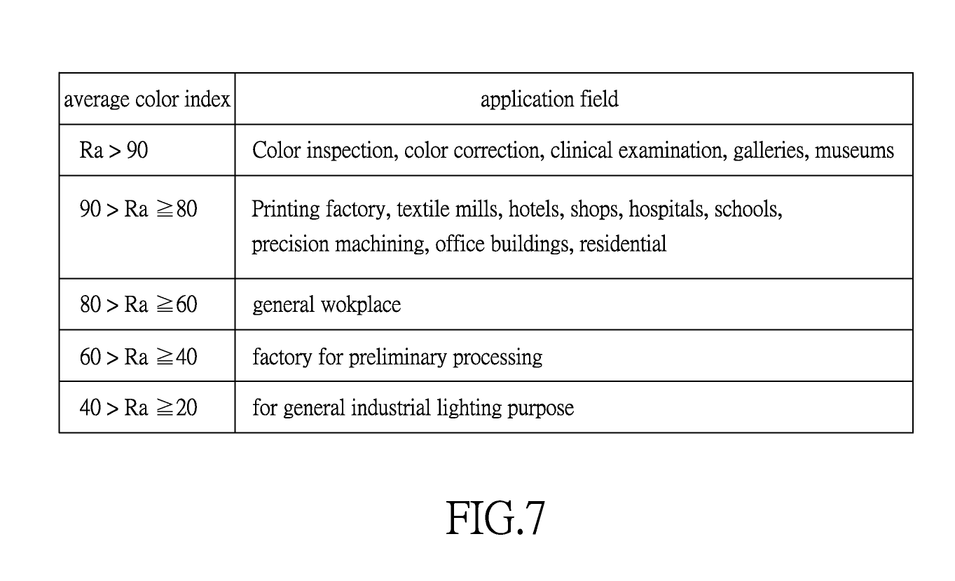

In real application, it is not that the color rendering performance can be improved simply by randomly increasing the blue and green light or yellow and white light. Although conventional method has been proposed to improve the color rendering performance by using mixed red light and white light, and the prior art also believes that mixed red, green and white lights can enhance color rendering performance. In fact, the improvement of color rendering performance is so limited that the resultant CRI (Ra) is never bigger than 90, when multiple LEDs of different colors are used together. According to the present invention, white lights with two specific wavelength ranges of red lights are mixed together in a specific proportion, so that the color rendering index Ra of the present invention has been increased to more than 90, and the practicability of the present invention is also considerably increased. As shown in FIG. 7, since the color rendering performance of the present invention can be bigger than 90, the lamp of the present invention is suitable for use in color inspection, color correction, clinical examination, gallery or museum.

While we have shown and described various embodiments in accordance with the present invention, it is clear to those skilled in the art that further embodiments may be made without departing from the scope of the present invention.

What is claimed is:

1. A high color rendering lamp comprising:
a light source with a substrate, a base light emitting unit and a compensation light unit, the base light emitting unit including a plurality of white LEDs disposed in a spaced manner on the substrate, the compensation light unit including a plurality of red LEDs disposed in a spaced manner on the substrate, and the red LEDs including short wavelength red LEDs and long wavelength red LEDs, a wavelength of a light of the short wavelength red LEDs being shorter than that of the long wavelength red LEDs; and
a power source electrically connected to the substrate and supplying power to the substrate to enable the base light emitting unit and the compensation light unit to generate light.

2. The high color rendering lamp as claimed in claim 1, wherein a proportion of the white LEDs to the red LEDs ranges from 3:1 to 6:1.

3. The high color rendering lamp as claimed in claim 2, wherein the proportion of the white LEDs to the red LEDs is 5:1.

4. The high color rendering lamp as claimed in claim 1, wherein a proportion of the short wavelength red LEDs to the long wavelength red LEDs ranges from 1:2 to 2:1.

5. The high color rendering lamp as claimed in claim 4, wherein the proportion of the short wavelength red LEDs to the long wavelength red LEDs is 1:1.

6. The high color rendering lamp as claimed in claim 1, wherein the short wavelength red LEDs and the long wavelength red LEDs have two different and non-overlapped wavelength ranges selected from a range of 620-750 nm.

7. The high color rendering lamp as claimed in claim 6, wherein the wavelengths of the short wavelength red LEDs and the long wavelength red LEDs are 620-670 nm and 670-750 nm, respectively.

8. The high color rendering lamp as claimed in claim 6, wherein the wavelengths of the short wavelength red LEDs and the long wavelength red LEDs are 620-640 nm and 650-670 nm, respectively.

9. The high color rendering lamp as claimed in claim 1 further comprising a radiating member disposed at one side of the power source, and a light reflection member surrounding the power source.

10. The high color rendering lamp as claimed in claim 9 further comprises a light diffuser shade fixed on the light reflection member and located toward the light source.
